(19) United States
(12) Patent Application Publication
(10) Pub. No.: US 2011/0061957 A1
(43) Pub. Date: Mar. 17, 2011

(54) Electric vehicle onboard energy producing apparatus

(76) Inventor: Michael Steven Hargett, Salem, OR (US)

(21) Appl. No.: 12/586,080

(22) Filed: Sep. 17, 2009

(51) Int. Cl. B60K 6/46; H02K 7/18

(52) U.S. Cl. 180/65.245; 290/1 A

(57) ABSTRACT

This apparatus is a mobile self-contained unit. The invention utilizes two distinct existing devices. The first device is an internal combustion engine. The second device is an electric generator that produces electric current. This apparatus is used to create electricity on board an electric vehicle while it is in motion. This invention burns many types of fuels for its power source, such as gasoline, propane, natural gas, bio diesel and ethanol to mention some of the most popular fuels. In the description for this application we are using hydrogen as its fuel. This would be considered a hydrogen-powered internal combustion engine. The internal combustion engine is mated together mechanically with an electric generator to produce electrical current. The hydrogen gas is burned as the fuel as it is produced. The hydrogen can be stored or made on board by using an electrolysis system. The invention in this application would be considered a hydrogen generator set. The most common name for this apparatus is known as a “genset.” The more common type of genset is powered by fossil fuels and other types of man-made fuels. The mobile aspect of this apparatus is such that it can be placed in many settings where electricity is needed to power equipment or drive an electric motor to move or turn a load. As an example, the invention can be placed onboard a vehicle or on small mobile platform with wheels; this makes it easily movable in shop or home situations, or it can also be mounted on a permanent frame if needed.

### FIELD OF THE INVENTION

The invention relates to an internal combustion engine, which is mechanically connected to a device which generates electrical current. The internal combustion engine drives a shaft which is connected to the electricity creating device's drive shaft. The internal combustion engine when it is in operation turns both of the two connected shafts which create the electrical current from the electrical generator. The electric current or energy which is created from the two connected shafts can be used to drive a load in an electric vehicle or a house in supplying electrical current. Or, as in this application, to charge energy storage devices on board the electric vehicle which is the means of the electricity to drive the electric vehicle.

### SUMMARY OF THE INVENTION

The present invention is an apparatus which is portable. The invention's portability is achieved by the means of adapting mechanical parts to allow the apparatus to move. To mention one such mechanical adaptation would be to have the apparatus mounted on wheels, a moveable frame which will allow physical movement of the apparatus. The mobility increases the adaptability for different applications. These applications can range from inside vehicles, or outside vehicles such as decks. As an example, the outside carry deck behind the cab of a tractor trailer vehicle, or inside a motor vehicle to generate electrical power.

The invention is comprised of two devices. The first device is an internal combustion engine. The second device is an electrical energy creating device, commonly known as an electrical generator. The first device is mated mechanically to the second device. Both the first and the second are mated together that when in operation together, will produce electrical energy to drive an electrical device or move a load. The invention's internal combustion engine is fueled and driven by hydrogen gas as fuel. The hydrogen gas used to power the internal combustion engine in this description. Fossil fuels are the main source for the fuels in the gensets. Most fuels are mainly petroleum based products. To mention a few, gasoline, natural gas and diesel.

Using hydrogen in this application as an example fuel, it has a benefit. The hydrogen when burned leaves no pollutant in the environment. In this invention the hydrogen is produced on board and is immediately burned as the powering fuel. However, the hydrogen can be stored on board also to power the hydrogen genset that produces the electrical current to recharge the on board electrical storage devices. These devices are commonly known as batteries or capacitors. These devices store the electrical energy that supplies the electric motor that drives the vehicle or an electric load.

### DESCRIPTION OF DRAWINGS

FIG. 1) shows a standard small internal combustion engine. This engine is a typical model in a combination which is matted with an electrical generator. This combination is referred to as a Genset. These small internal combustion engines come in a variety of horse power ranges and sizes.

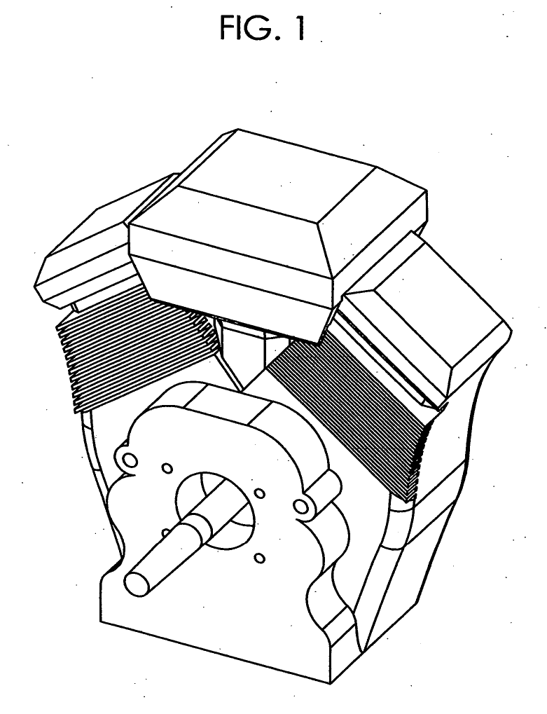

FIG. 2): shows in this drawing a standard electrical generator. The size of the generator would be selected to produce a certain amount of electrical current in relation to the internal combustion engine.

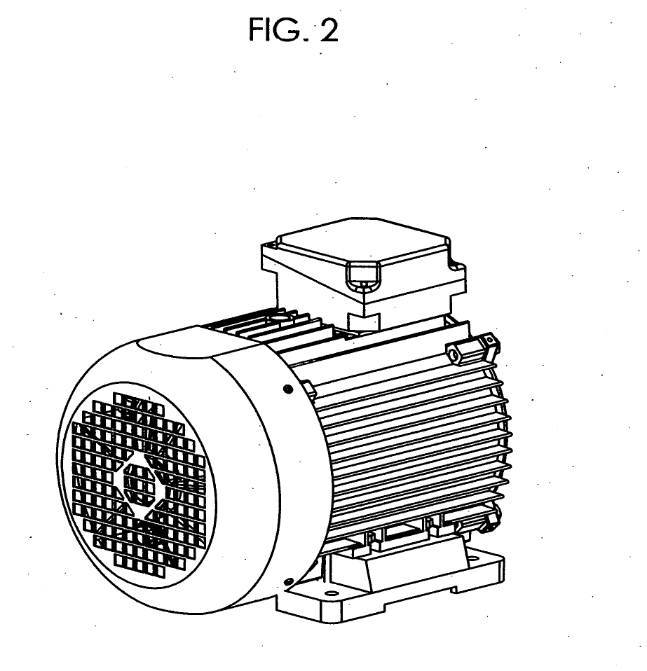

FIG. 3): shows the small internal combustion engine and the generator in a close arrangement. This is in the assembly configuration is just as they are being matted together to make up a genset.

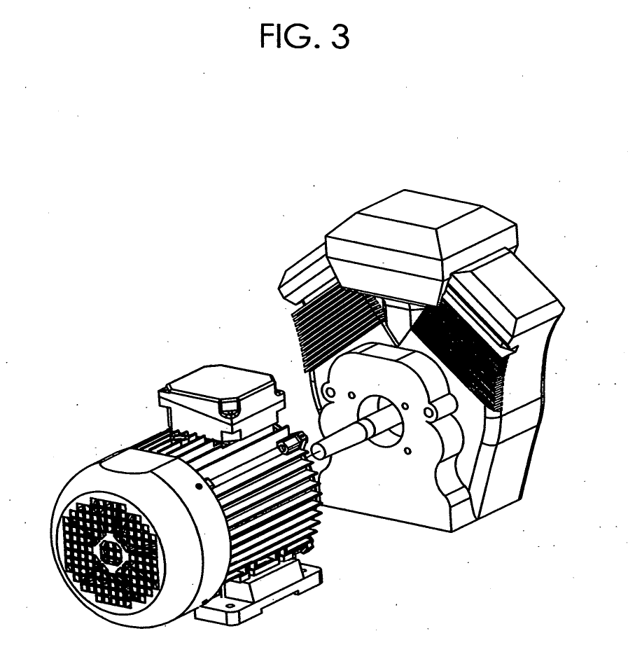

### PREFERRED EMBODIMENT

It is known that the electric vehicle has to be plugged in to an electrical power supply to recharge the storage devices such as batteries or capacitors. These devices supply the electric current to power to the electric motor. These electric motor's are installed in many types of vehicle such as cars, trains, buses, ships, cranes, underground equipment and many more vehicles that are powered by electricity to drive a load. Taking the genset combination fossil fuel engine and the electric generator and placing it in the vehicle itself allowing the electric current to be produced on board the vehicle it is applied to, thus allowing the electric vehicle to continue it operation or work without having to stop to charge the electrical storage devices back up to the full capacity. The vehicle can then be operated at long periods of time without having to stop and plug the unit into an electric supply source. The most common source is named the electric power grid. By eliminating the need to plug the electric vehicle into the power grid does not require the additional sums of coal, nuclear energy and also other type's fuels to be used to power these electric power generating stations. It is well known that all of the United States citizens could not plug their electric vehicles into the existing electrical power grid without causing great additional demand on the fuels needed to supply to create the electricity needed to recharge the electrical storage devices in these vehicles.

This invention eliminates the need to plug into the electric power grid, alleviating the burden of the demand for more foreign oils and the need to build new electricity power stations for the specific need to supply the electric vehicle with the electricity to recharge the electricity storage devices. The electrical power grid requires fuel to burn to generate the electricity which if taken into consideration the population of the United States the amount would be an additional burden to supply the demand expressly for the electric vehicle and its electrical power needs. It is known that the United States could not support an entire nation of electric vehicles and maintain the demand for electricity to power the nation in its daily use. The nations demand for electrical current is ever growing. It is also noted, the generation of electricity from these electrical power stations are powered in most part by harmful types of fuels. Some of these fuels come from outside of the united States of America. These supplies of fuel are produced by nations that are not politically connected or remain unfriendly to the political structure of the United States of America. This production increases our dependency on these nation's fuels and causes political duress in the political structure of the nation. The application of this invention is its means to adapt with the growing demand. The inventions adaptability of this is that it is a separate power generation unit that is placed in the vehicle. It further creates its versatility by using many types of fuels that are available to burn as fuel.

This invention which uses as its means to create the electrical current on board the vehicle while in motion or traveling, allows the electric vehicle to not have to be taken out of service to be plugged into an electrical power supply. This means also utilizes the best fuels possible as its fuel. The onboard power station utilizes the clean burning fuels such as hydrogen as one of many. The petroleum based fuels can be scrubbed so as to offer a cleaner exhaust and decrease the carbon footprint that is causing the green house gas effect and is related to global warming. Simply put the invention utilizes the means to create electricity onboard the vehicle and burns clean fuels as well as those that be scrubbed clean without having to stop and take the vehicle out of service.

1) The method of claim (1) is the use of an onboard genset that can be powered by multiple types of fuels to create electrical current to be used to either recharge batteries or to drive the vehicle itself using the electrical current.

2) This method in claim (2) is the use of a mobile hydrogen powered internal combustion engine, mechanically mated with an electrical current generator. The combination of the two devices creates electrical current to drive a load, charge batteries or capacitors in an electric vehicle.

3) The method in claim (3) is the use of a mobile powered internal combustion engine and an electrical generator mated mechanically together to generate electrical current to charge energy storage devices onboard an electric vehicle.
